(19) United States
(12) Patent Application Publication
(10) Pub. No.: US 2013/0185165 A1
(43) Pub. Date: Jul. 18, 2013

(54) MEDIA EXCHANGE PLATFORM

(71) Applicant: MySpace, LLC, Beverly Hills, CA (US)

(72) Inventors: Timothy Charles Vanderhook, Newport Beach, CA (US); Jason J. A. Knapp, Solana Beach, CA (US); Brian C. DeFrancesco, Trabuco Canyon, CA (US); Christopher John Vanderhook, Placentia, CA (US)

(73) Assignee: MySpace, LLC, Beverly Hills, CA (US)

(21) Appl. No.: 13/744,716

(22) Filed: Jan. 18, 2013

Related U.S. Application Data
(60) Provisional application No. 61/588,042, filed on Jan. 18, 2012.
(60) Provisional application No. 61/606,883, filed on Mar. 5, 2012.

(51) Int. Cl. H04L 29/08

(52) U.S. Cl. CPC H04L 67/32; G06Q 30/0277
USPC 705/14.73; 709/217

(57) ABSTRACT

A method, apparatus, and computer-readable medium provide the ability to exchange media content. A media content request is received at a website from a user. In response to the media content request, the website requests the media content in the media content request from a decisioning engine. In reply, the website receives a media asset or an identifier for the media asset. The media asset or the media asset identifier is then delivered to the user for consumption.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/588,042, entitled “MEDIA EXCHANGE PLATFORM”, by Timothy Charles Vanderhook, Jason J. A. Knapp, and Briand C. DeFrancesco, filed on Jan. 18, 2012, Attorney Docket No. 257.9-US-P1; and

U.S. Patent Application Ser. No. 61/606,883, entitled “MEDIA CONTENT SELECTION SYSTEM AND METHODOLOGY”, by Timothy Charles

Vanderhook, Jason J. A. Knapp, Brian C. Defrancesco, and Christopher John Vanderhook, Attorney Docket No. 257.10-US-P1, filed on Mar. 5, 2012.

### BACKGROUND OF THE INVENTION

1. Field of the Invention

The present invention relates generally to content delivery via an electronic network, and in particular, to a method, apparatus, and article of manufacture for a platform that enables real-time buying and selling of content.

2. Description of the Related Art

In traditional Internet communications, a user requests a web page (via a link or by typing in a uniform resource locator (URL) in a web page). Alternatively, in a media player, a user may also request media content (e.g., music, video/audio, text, graphics, etc.). Such a request may be for a specific piece of media content (e.g., a particular song) or may be for a category of content (e.g., rock music). In response, a server is responsible for determining/selecting and delivering the content to the user. Traditionally, the particular content that is delivered to the user is either the specific content requested by the user or is selected via a single selection algorithm such as a collaborative filter algorithm. However, such a single selection algorithm fails to meet the flexibility and customization needed to deliver certain content to users. In this regard, certain content owners may be willing to incur additional charges for prioritized selection/delivery of their content. The prior art fails to provide a means for enabling such selection/delivery.

### SUMMARY OF THE INVENTION

Embodiments of the invention provide a media exchange platform (MEP) that is a platform that enables real time buying and selling of content exposure and media consumption. A decision and transaction processing engine provides the ability to flexibly select the content that is to be delivered to a user. Such an engine further enables the use of a selection system that may utilize a variety of different selection systems/algorithms in combination with each other.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention; and

FIG. 3 illustrates the flow of the media exchange platform in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

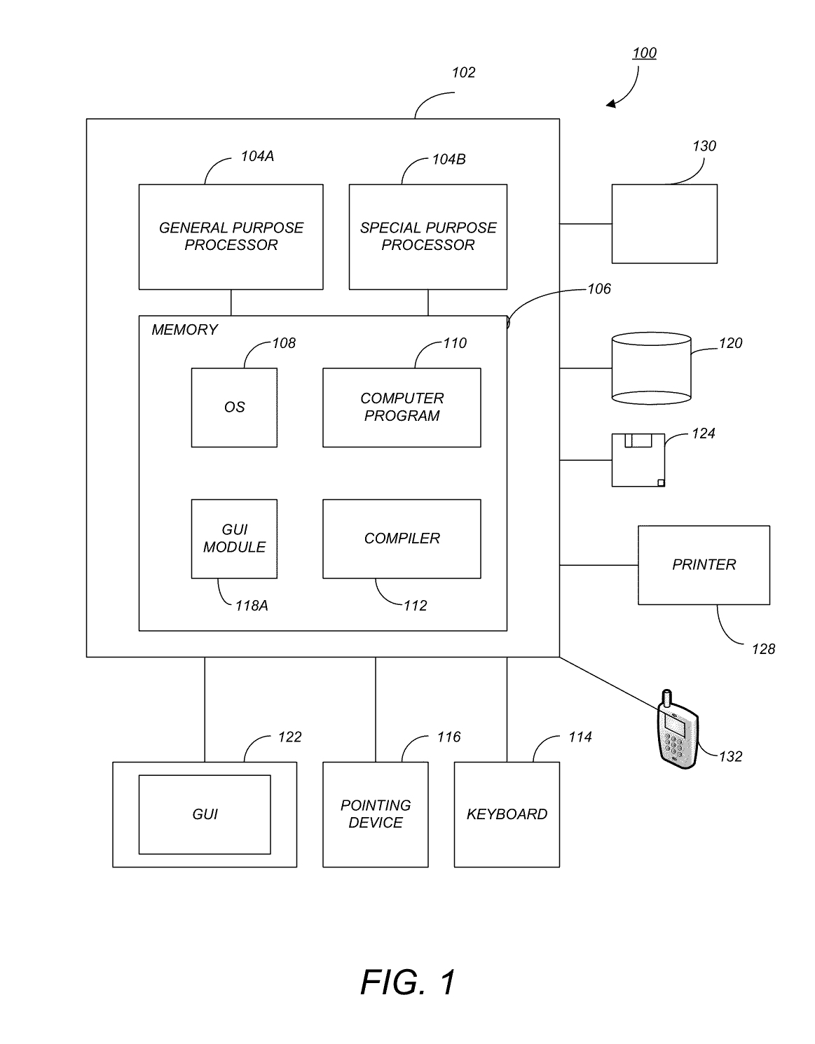

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may comprise or may be coupled to and/or integrated with other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to or may comprise a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus STM, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

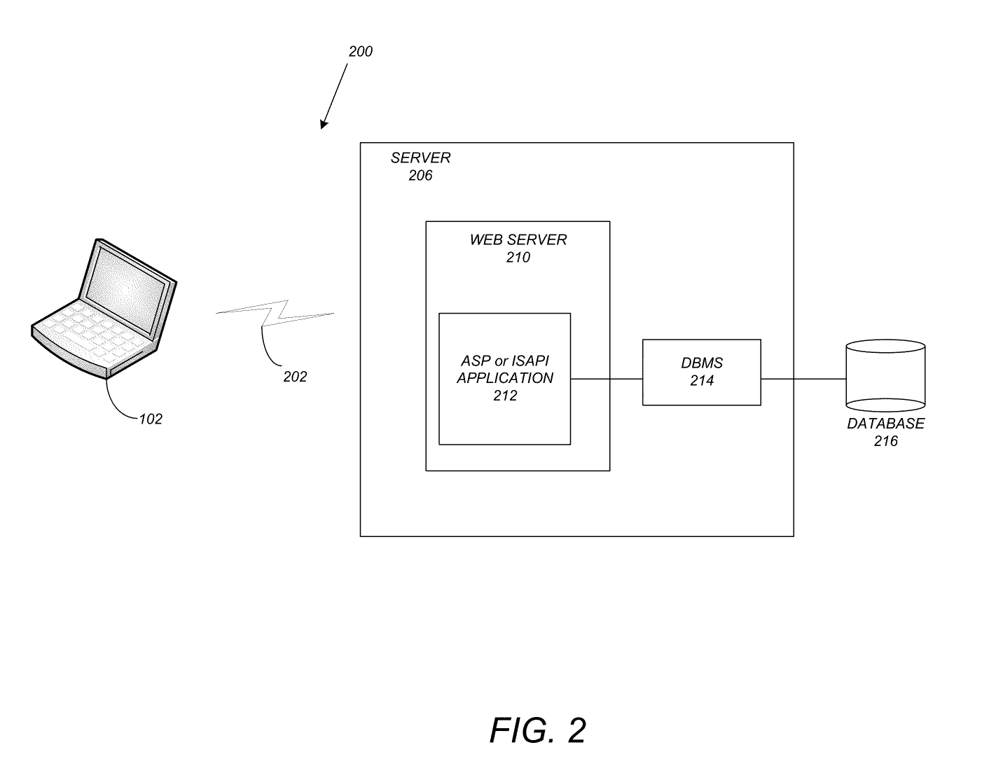

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 may be utilized for embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 102 may be downloaded from server computer 206 to client computers 102 and installed as a plug in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of or connected directly to client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include thin client devices with limited or full processing capabilities, portable devices such as cell phones, notebook computers, pocket computers, multi-touch devices, and/or any other device with suitable processing, communication, and input/output capability.

Of course, those skilled in the art will recognize that any combination of the above components, or any number of different components, peripherals, and other devices, may be used with computers 102 and 206.

### Software Embodiments

Embodiments of the invention are implemented as a software application (i.e., a media exchange platform [MEP]) executing on a client 102, server computer 206, or a combination of both client 102 and server 206. Further, as described above, the client 102 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems.

The MEP is a platform that enables real time buying and selling of content exposure and media consumption. The sellers are internet properties operating websites or applications with dynamic media streaming or dynamic content displaying capabilities. The buyers are artists, producers, performers, entertainers, advertisers, or other parties who create or represent creators of content or media that would like to promote their content (media) by driving increased exposure through paying for consumption (exposure) to target audiences. Media can be music, video, or any multimedia digital streaming format. Content can be text and/or graphic based including articles, links, images, animations, etc. As used herein, media content refers to media and/or content that may be exchanged (e.g., bought or sold)

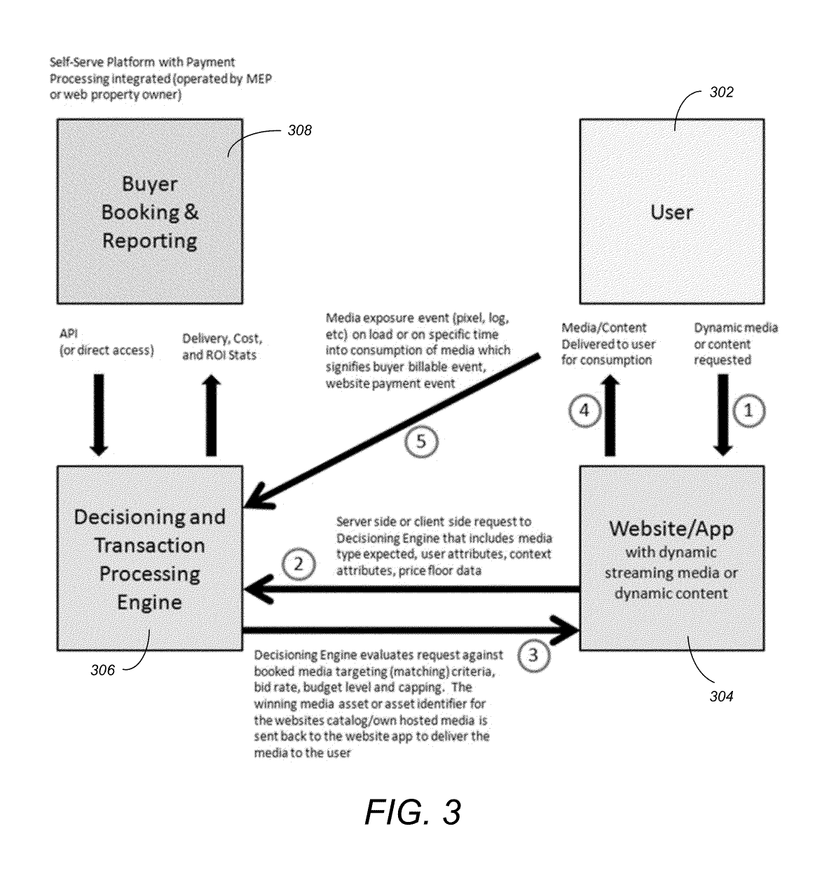

FIG. 3 illustrates the flow of the media content exchange platform in accordance with one or more embodiments of the invention.

As illustrated, the first step (1) is that of the user 302 (e.g., client 102) requesting dynamic media or content from a website/application 304 (e.g., server 206).

In response, at (2), the website/application 304 conducts a server side or client side request to a decisioning engine 306. The request includes the media type expected, the user attributes, the context attributes, and price floor data. In reply, at (3), the decisioning engine 306 evaluates the request against booked media targeting (matching) criteria, bid rate, budget level, and capping. The winning media asset or asset identifier for the websites/catalog/own hosted media is sent back to the website application 304 to deliver the media to the user 302.

Thus, as illustrated at arrow (4), the media/content is delivered to the user for consumption. In addition, at (5), the media exposure event may be transmitted from the user 302 to the decisioning engine 306. Such a media exposure event may comprise a pixel, a log, etc. that is delivered to the decisioning engine 306 when the media/content is loaded, or on a specific time into the consumption of the media. Such a media exposure event signifies a buyer billable event/website payment event has occurred. Accordingly, the media exposure event is used to track when the media has been consumed by the user 302 thereby requiring payment from the buyer 308.

In addition to steps (1)-(5) described above, the decisioning engine 306 may conduct interactions with the buyer booking and reporting engine 308 in order to manage and obtain the content to be delivered to the website/application 304. In this regard, the buyer booking and reporting component may be a self-serve platform with payment processing integrated. Further, the engine 308 may be operated by/part of the MEP or a web property owner.

To enable the buyer booking and reporting component 308 to provide content, the buyer booking and reporting component 308 accesses the decision engine 306 directly or via an application programming interface (API). The content may also be uploaded either directly through the booking engine 308 and then transferred into the decisioning platform 306 from the API or via direct access between the two systems 306 and 308. Alternatively, the content may be uploaded to/on the website 304 and the buyer inputs the website's content identifier (i.e., unique id).

To inform the buyer 308 of which media has been consumed (and to provide an accounting), the decisioning engine 306 may provide the delivery, cost, and return on investment (ROI) statistics to the buyer 308.

### Individual Component Details

The various components 302-308 enable the media exchange platform. The sections below provide details regarding each of the components 302-308.

User 302

The user 302 is a person visiting a website or using a web based application to consume content or media (i.e., via a client device 102).

Website/Application 304

The website/application 304 is a website, web application, or media platform that provides all or portions of the process to curate, dynamically stream media, or display dynamic content to users (e.g., server 206). Examples include: MySpace™ Music, Pandora.com™, VHX.tv™, and Redux.com™

Decision and Transaction Processing Engine 306

The decisioning and transaction processing engine 306 (also referred to herein as the media exchange platform (MEP)) is the engine 306 that enables the exchange of information as described herein. Accordingly, the MEP/engine 306 is a multi-platform system that can handle requests server side 206 and client side 102 and respond in a variety of formats depending on the preference of the website/application 304. Applications and websites 304 can initiate requests for content/media through the MEP 304 via any devices on any platform as long as TCP/IP (transmission control protocol/internet protocol) connectivity is enabled. This includes personal computers (PCs), tablets, mobile phones, gaming systems, IP (internet protocol) enabled television, television set top boxes, or other internet enabled devices running on various platforms and operating systems.

The transaction flow starts with the MEP 306 receiving a TCP/IP request sent from the website, application, or platform 304. This request will contain information passed through the website/application 304 that may include but is not limited to:
User Identifier (unique user id)
IP address
Connection Speed
Location
User Agent String
Device
User Attributes
   Demographics
   Lifestyle Likes, Dislikes, Interests, Friends, Behaviors
   Any Website/Application Preferences
   Media Consumption likes, dislikes, preferences, and consumption history
Webpage/Media Channel context
Content Type requested

The request data parameters are weighted against the booked exposure campaigns, their content attributes, targeting attributes, audience attributes, delivery criteria, and bid rate. A selection algorithm will choose the winning content based on the maximum value. The maximum value may be defined by a variety of mechanisms and attributes that may include bid amount, relevance, predicted performance (e.g., like, dislike, call to action) or any combination of these.

In addition, rather than relying on a particular method for selecting the content, embodiments of the invention may utilize a combination of multiple different selection methodologies. For example, instead of relying exclusively on a collaborative filtering algorithm to select the content, a combination of the collaborative filtering algorithm with another methodology may be utilized. In this regard, embodiments of the invention may utilize a collaborative filtering system to select content eighty percent (80%) of the time, and selecting content based on payment from a content owner/buyer the remaining twenty percent (20%) of the time. The content selected twenty percent of the time may be content that is not normally provided and may be marked as a sponsored song (e.g., by the website/application 304 or when played by the user 302).

More than two different selection methodologies may also be utilized. For example, the following combination may be utilized:
80% of the time: based on the user's preferences (e.g., based on what the user may like);
10% of the time: based on a pay for play (where the content owner pays to have the owner's content delivered/viewed by the user); and
10% of the time: based on a learning algorithm (e.g., a song that is trending in the correct genre to see if the user likes the song or not).

Eventually, a song played for payment may be included in a collaborative filtering selection system (e.g., if multiple users indicate a like/preference for such a song). In addition, the user experience may be managed by setting conditions on how often the pay for play may occur. Such a pay for play system may allow a media content owner/promoter to help undiscovered talent/artists that haven't yet signed with a “label” receive more airtime for their content (e.g., music, video, etc.). There may also be a combination of pay-for-play with other features. For example, a buyer may prefer to pay for the play of his/her content only when the user 302 has a preference for content in the same genre (e.g., rock music) and/or if certain content is “trending” or has recently become popular (e.g., if the content is a viral video or if the user 302 is viewing similar content in the user's current viewing session rather than merely shopping [e.g., the engine 306 may be attempting to predict the current user's 302 mood for exposure to particular media content]). Thus, each of the different selection methodologies may be utilized independently from or in combination with other selection methodologies to optimize the user 302 experience with such content.

The percentages and use of different selection methodologies may also be modified dynamically on the fly as more content is received by/viewed by the user 302. For example, the time of day, user profile, current user's response to particular content, internet speed, etc. (any type of attribute) may be used to adjust the percentages for which each selection methodology is used to select content. For example, suppose a pay-for-play selection is used eighty percent (80%) of the time and based on such a methodology, a particular song is recommended to a user, who in response indicates a “like” for such content. In such a circumstance, the system may increase the percentage of time that pay-for-play is used up for that user/class/type of user (e.g., based on an assumption that this user likes to receive recommendations and may have a positive experience for such content). Similarly, if a user skips all pay-for-play content whenever presented to a user without further input, embodiments of the invention may decrease the percentage of time that pay-for-play content is provided to such a user.

Such adjustments to the percentages of time a particular selection methodology is used may be performed dynamically based on a set (predefined or otherwise) of rules/preferences or may be adjusted based on an evaluation of the success/failure of a particular combination/percentages from the view of the engine 306, user 302, website 304, and/or content owner/buyer.

Once selected, the chosen media asset or asset identifier is sent back to the application/web service 304 to be displayed/streamed to the user 302 and a billable event is triggered (via secondary TCP/IP request) on the agreed upon consumption point (ex. display, initial play, 30 seconds of play, etc) and forwarded to the buyer booking and reporting component 308.

Buyer Booking and Reporting 308

The buyer booking and reporting component 308 is a component of the media exchange platform that allows a buyer to input and update his/her/their contact and billing information. It also enables the buyer to input and update pay per exposure campaign information, which includes but is not limited to:
Content
   Content (media) to be delivered to the user 302 (or equivalent identifier for media/content in web property's catalog).
      Ex. XML: <song_id>120392</songid>which could be Adele —Rolling in the Deep in a website's music database
   Content type
      Ex. Streaming Audio
   Quality
      Ex. 128 kbps
   Content display/play technical requirements: device, browser (if applicable), dependencies (ex. flash player), connection speed
      Ex. All Devices, All Platforms, All Browsers, All Connection Speeds
Budget
   Maximum bid per exposure
      The buyer 302 cannot be charged more than this amount for any single content exposure
   Total budget
      The total amount allocation to running a played exposure campaign. Once this limit is reached the campaign is suspended until further budget (funds) are allocated.
   Maximum budget per periods of time (day, week, month)
      While the total budget dictates the overall funds allocated for this campaign, the buyer can also specify a maximum budget that can be used per day, week, or month
Target Audience
   Geography
      Ex. North America, United States, California, Los Angeles, 92679
      Ex. GPS coordinates range
   Demographics
      Ex. Age, Gender, Income, Religious Beliefs, Ethnicity
   Lifestyle Interests, Likes, Dislikes, and Behavior data criteria (shared by website/app with MEP or MEP proprietary data)
   Media Consumption likes, dislikes, preferences, and consumption history
Target Context
   Page content category
   Genre, Classification, Similar Artists, Year, etc for media
Delivery Restrictions
   Frequency
      Ex. maximum 3 exposures per user per week
   Day of Week
      Ex. Only run Fridays and Saturdays
   Time of Day
      Ex. Only run 4 pm-12 am

In addition, once a campaign is running, a buyer will be able to access and view delivery and exposure statistics including the total billable events.

Exemplary Transaction

In view of the different components of FIG. 3 described above, an exemplary transaction utilizing the various components may be useful. A music streaming website 304 that has a “Radio” playing feature to dynamically stream music to the user 302 based on the genre of the station the user 302 selects. All or a portion of the song plays could be monetized for the website 304 by sending a request for songs through the MEP 306. An example request could look like:
User Identifier (unique user id): 1234567823
IP address: 1.1.2.3
Connection Speed: 5 Mbps
Location: 28.203519,-80.59648
User Agent String: Mozilla/5.0 (Macintosh; Intel Mac OS X 10_{—}6_{—}8) AppleWebKit/535.7 (KHTML, like Gecko) Chrome/16.0.912.75 Safari/535.7
Device: MacBook Pro
User Attributes
   Demographics
      Male: 25-35, Conservative
   Lifestyle Likes, Dislikes, Interests, Friends, Behaviors
      Ex. Outdoorsman, likes Ford, Budweiser, Economical Online Shopper
   Any Website/Application Preferences
      No Streaming Quality less than 128 kbps
   Media Consumption likes, dislikes, preferences, and consumption history
      Ex. Mostly listens to new country, 80's hair band music, likes Jason Aldean, Dierks Bentley, dislikes techno and Kayne West
Webpage/Media Channel context
   Genre: Alternative
Content Type requested
   Streaming Audio

The MEP 306 would respond (to the website 304) with an audio asset identifier (ex. song id 123456) based on media in the same or similar genre with the closest relevancy match to the user 302 based on the user's consumption history and the highest bid rate among the close matching assets. The website 304 would receive this winning song id, locate the asset in the website's 304 catalog of music and stream the song to the user 302. The buyer (content owner) would be charged for this play (via the booking and reporting engine 308) and the website 304 would be paid to play this song minus a fee charged by a MEP 306.

### CONCLUSION

This concludes the description of the preferred embodiment of the invention.

The following describes some alternative embodiments for accomplishing the present invention. For example, any type of computer, such as a mainframe, minicomputer, or personal computer, or computer configuration, such as a timesharing mainframe, local area network, standalone personal computer, multi-touch device, internet enabled device, etc. could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for exchanging media content, comprising:
receiving a media content request, at a website from a user;
in response to the media content request, the website requesting the media content in the media content request from a decisioning engine;
receiving, in reply from the decisioning engine, a media asset or an identifier for the media asset; and
delivering the media asset or the media asset identifier to the user for consumption.

2. The computer-implemented method of claim 1, wherein the media content request comprises:
an expected media type;
a user attribute;
a context attribute; and
price floor data.

3. The computer-implemented method of claim 1, wherein the decisioning engine is configured to:
evaluate the media content request against booked media targeting criteria, bid rate, budget level, and capping;
determine a winning media asset based on the evaluation; and
transmit the winning media asset or an identifier for the winning media asset to the website.

4. The computer-implemented method of claim 1, further comprising:
the decisioning engine receiving a media exposure event that signifies an occurrence of a billable event.

5. The computer-implemented method of claim 4, wherein the media exposure event comprises information that is delivered to the decisioning engine when the media content is loaded.

6. The computer-implemented method of claim 1, wherein:
the decisioning engine communicates with a reporting engine to manage and obtain the media content to be delivered to the website.

7. The computer-implemented method of claim 6, wherein the decisioning engine communicates with the reporting engine via an application programming interface (API) of the decisioning engine.

8. The computer-implemented method of claim 1, wherein the decisioning engine provides statistics regarding delivery, cost, and return on investment to a buyer.

9. An apparatus for exchanging media content in a computer system comprising:
(a) a computer having a memory;
(b) an application executing on the computer, wherein the application is configured to:
(1) receive a media content request, from a user;
(2) in response to the media content request, request the media content in the media content request from a decisioning engine;
(3) receive, in reply from the decisioning engine, a media asset or an identifier for the media asset; and
(4) deliver the media asset or the media asset identifier to the user for consumption.

10. The apparatus of claim 9, wherein the media content request comprises:
an expected media type;
a user attribute;
a context attribute; and
price floor data.

11. The apparatus of claim 9, wherein the decisioning engine is configured to:
evaluate the media content request against booked media targeting criteria, bid rate, budget level, and capping;
determine a winning media asset based on the evaluation; and
transmit the winning media asset or an identifier for the winning media asset to the website.

12. The apparatus of claim 9, wherein:
the decisioning engine receives a media exposure event that signifies an occurrence of a billable event.

13. The apparatus of claim 12, wherein the media exposure event comprises information that is delivered to the decisioning engine when the media content is loaded.

14. The apparatus of claim 9, wherein:
the decisioning engine communicates with a reporting engine to manage and obtain the media content to be delivered to the website.

15. The apparatus of claim 14, wherein the decisioning engine communicates with the reporting engine via an application programming interface (API) of the decisioning engine.

16. The apparatus of claim 9, wherein the decisioning engine provides statistics regarding delivery, cost, and return on investment to a buyer.

17. A computer readable storage medium encoded with computer program instructions which when accessed by a computer cause the computer to load the program instructions to a memory therein creating a special purpose data structure causing the computer to operate as a specially programmed computer, executing a method of exchanging media content, comprising:
(a) receiving, in the specially programmed computer at a website, a media content request from a user;
(b) in response to the media content request, the website requesting, via the specially programmed computer, the media content in the media content request from a decisioning engine;
(c) receiving, in the specially programmed computer, in reply from the decisioning engine, a media asset or an identifier for the media asset; and
(d) delivering, via the specially programmed computer, the media asset or the media asset identifier to the user for consumption.

18. The computer readable storage medium of claim 17, wherein the media content request comprises:
an expected media type;
a user attribute;
a context attribute; and
price floor data.

19. The computer readable storage medium of claim 17, wherein the decisioning engine is configured to:
evaluate the media content request against booked media targeting criteria, bid rate, budget level, and capping;
determine a winning media asset based on the evaluation; and
transmit the winning media asset or an identifier for the winning media asset to the website.

20. The computer readable storage medium of claim 17, wherein:
the decisioning engine receives a media exposure event that signifies an occurrence of a billable event.

21. The computer readable storage medium of claim 20, wherein the media exposure event comprises information that is delivered to the decisioning engine when the media content is loaded.

22. The computer readable storage medium of claim 17, wherein:
the decisioning engine communicates with a reporting engine to manage and obtain the media content to be delivered to the website.

23. The computer readable storage medium of claim 22, wherein the decisioning engine communicates with the reporting engine via an application programming interface (API) of the decisioning engine.

24. The computer readable storage medium of claim 17, wherein the decisioning engine provides statistics regarding delivery, cost, and return on investment to a buyer.
